(19) United States
(12) Patent Application Publication
(10) Pub. No.: US 2021/0174594 A1
(43) Pub. Date: Jun. 10, 2021

(54) VIRTUALIZED ENVIRONMENT FOR THREE-DIMENSIONAL PRINTING

(71) Applicant: Hewlett-Packard Development Company, L.P., Spring, TX (US)

(72) Inventors: Wei Huang, Palo Alto, CA (US); Gary J Dispoto, Palo Alto, CA (US)

(73) Assignee: Hewlett-Packard Development Company, L.P., Spring, TX (US)

(21) Appl. No.: 17/047,364

(22) PCT Filed: Aug. 28, 2018
(86) PCT No.: PCT/US2018/048362

§ 371 Date: Oct. 13, 2020

(51) Int. Cl. G06T 19/00; B33Y 30/00; B33Y 50/02; B29C 64/393; B22F 10/85

(52) U.S. Cl. CPC G06T 19/006; B33Y 30/00; B22F 10/85; B29C 64/393; B33Y 50/02

(57) ABSTRACT

An example system includes a three-dimensional (3D) printer to produce a 3D working product. The 3D working product includes cured material forming a printed portion of a 3D object and uncured material, and the printed portion of the 3D object is at least partly embedded in the uncured material. The example system further includes a controller to generate a virtualized image of at least a part of the 3D object and a display coupled to the controller, the display to display a virtualized environment, the virtualized environment including the virtualized image of the 3D object, the virtualized image of the 3D object corresponding to at least a part of the printed portion of the 3D object.

### BACKGROUND

Three-dimensional (3D) printing is becoming ubiquitous in a variety of environments. For example, many manufacturing arrangements regularly utilize 3D printing to manufacture or facilitate the manufacturing of various components. Further, 3D printers are becoming accessible to smaller entities and individuals. Three-dimensional printers operate with carriages performing various tasks. For example, one carriage may deposit material in layers, and another carriage may apply energy to selectively fuse the material.

### BRIEF DESCRIPTION OF THE DRAWINGS

For a more complete understanding of various examples, reference is now made to the following description taken in connection with the accompanying drawings in which:

FIG. 1 illustrates an example virtualization system for three-dimensional (3D) printing;

FIG. 2 illustrates another example virtualization system;

FIG. 3 illustrates another example virtualization system;

FIG. 4 illustrates another example virtualization system;

FIG. 5 illustrates another example virtualization system;

FIG. 6 is a flow chart illustrating an example method for displaying a virtualized environment for 3D printing; and

FIG. 7 illustrates a block diagram of an example system with a computer-readable storage medium including instructions executable by a processor for displaying a virtualized environment for 3D printing.

### DETAILED DESCRIPTION

As noted above, some examples of 3D printing include depositing material in layers, and selectively fusing, or curing, portions of each layer of the material. As the printing progresses, the cured portion (e.g., portion of the object that has been printed) is substantially or completely embedded in the uncured material. Thus, monitoring the progress of the printing of the object may be difficult or impossible.

Various examples described herein relate to the use of virtualization displays (e.g., virtual reality or augmented reality) to present a model of an object being printed on a three-dimensional (3D) printer. In various examples, the 3D printer may print an object by curing (e.g., fusing) material while retaining uncured material around the cured material. For example, the uncured material may be loose powder which can be removed upon completion of the printing process. In various examples, a display, such as a head-mounted display or a monitor, may be used to present the current state of the printing (e.g., the working product with the cured material surrounded by the uncured material or the printed portion formed by the cured material) overlaid with an image (e.g., digital model or virtualized image) of the completed object. Thus, a user can view which parts of the 3D object have been printed and which parts still remain to be printed.

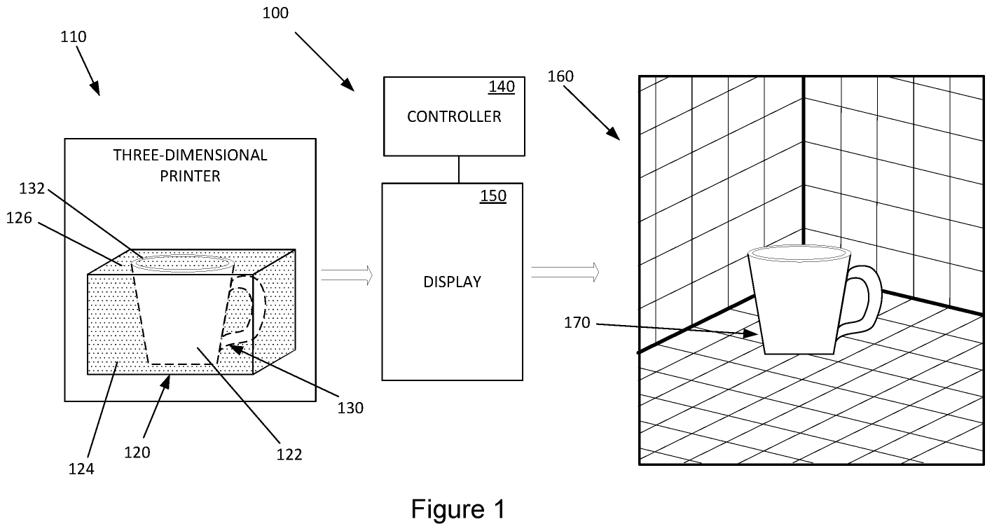

Referring now to FIG. 1, an example virtualization system for 3D printing 100 is illustrated. The example system 100 includes a 3D printer 110 to generate a 3D object, such as the object 130 illustrated in FIG. 1. During the printing process, the 3D printer 110 produces a working product 120 which includes cured material 122 forming at least part of a 3D object 130 and uncured material 124. As illustrated by the dotted lines in FIG. 1, the printed portion of the 3D object 130 is embedded in the uncured material 124 and is not visible. A top layer 126 of the working product 120 is visible, thus exposing a top layer 132 of the printed portion of the 3D object 130, as indicated by the solid line in FIG. 1.

The example system 100 of FIG. 1 further includes a controller 140 and a display 150. The display 150 is provided to display a virtualized environment, such as the virtualized environment 160 illustrated in FIG. 1. In the example system 100 of FIG. 1, the virtualized environment 160 includes an image 170 of the printed portion of the 3D object 130 formed by the fused material 122. The image 170 may be electronically generated based on information from the 3D printer indicative of the printed portion of the 3D object 130. In some examples, the image 170 may be generated by the controller 140 based on an image of the top layer 132 of the printed portion of the 3D object. For example, based on the visible top layer 132, the controller may determine the status of the printing of the 3D object (e.g., percent complete) and generate the image 170 to indicate the status.

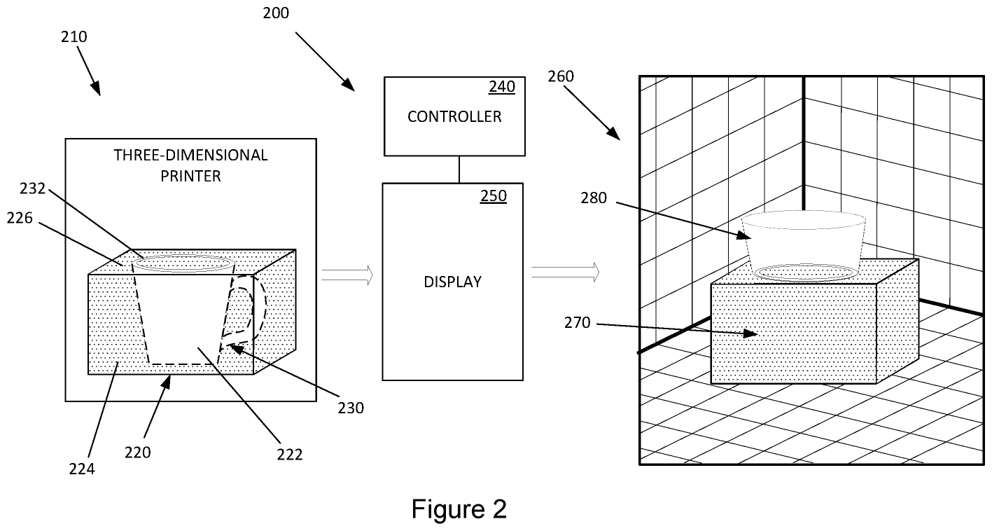

Referring now to FIG. 2, another example virtualization system for 3D printing is illustrated. The example system 200 includes a 3D printer 210 for printing 3D objects. The example system 200 includes a 3D printer 210 to generate a 3D object, such as the object 230 illustrated in FIG. 2. Three-dimensional printers may employ any of a variety of 3D printing technologies including, but not limited to, multi-jet fusion (MJF), fused deposition modeling (FDM), selective laser sintering (SLS), selective laser melting (SLM), electronic beam melting (EBM), or stereolithography (SLA). Some of these technologies, such as SLS, MJF, SLM or EBM, provide layers of loose material, such as powder (e.g., nylon, polyamide or metal), with selected portions of each layer that are fused, or cured, to form the 3D object. In this regard, the 3D printer 210 may include various components, such as carriages to distribute build material and to cure (e.g., fuse) the build material. In various examples, as noted above, the build material may be a powder, such as a polymer powder or a metal powder.

Referring again to FIG. 2, during the printing process, the 3D printer 210 produces a working product 220 (also referred to as a build bed) formed by various layers of deposited build material. As selected portions of each layer are fused, the working product 220 includes cured material 222 forming at least part of a 3D object 230 and uncured material 224. Thus, the cured material 222 forms a printed portion of the 3D object 230. Once the printing of the 3D object 230 is complete, the uncured material 224 can be removed, and the completed 3D object 230 can be obtained. As illustrated by the dotted lines in FIG. 1, the printed portion of the 3D object 230 is embedded in the uncured material 224 and is not visible. The top layer 226 of the working product 220 is visible, thus exposing the top layer 232 of the printed portion of the 3D object 230, as indicated by the solid line in FIG. 2.

The example system 200 of FIG. 2 further includes a controller 240 and a display 250. In various examples, the display 250 may be a head-mounted display or a monitor. The display 250 is provided to display a virtualized environment, such as the virtual environment 260 illustrated in FIG. 2. As used herein, virtualized environment includes virtual reality, as well as augmented reality in which virtual content or objects and physical content or objects are displayed together. In some examples of augmented reality systems, the user is provided with a direct view of the physical environment, and virtual elements are overlaid, or overlapped, onto the physical environment via, for example, a half-silvered mirror. In this regard, virtual elements may augment the physical environment of the user. In some examples, the direct view of the physical environment may be replaced with an image captured by a camera. For example, the display may include an image captured by a camera of the top layer 226 of the working product and/or the top layer 232 of the printed portion of the 3D object 230.

In the example system 200 of FIG. 2, the virtualized environment 260 includes an image 270 of the 3D working product 220. In some examples, the display 250 is a head-mounted display, and the image 270 of the 3D working product 220 may be displayed in an augmented reality in which the image 270 is viewed in the head-mounted display through a half-silvered mirror. In other examples, the image 270 may be an image of the working product 220 captured by a camera. In some examples, the image 270 may be electronically generated based on information from the 3D printer indicative of the working product or the printed portion of the 3D object 230. In this regard, the controller 240 may receive the printing status from the 3D printer 210 or receive an image of the visible top layer 226 of the working product 220 and use this information to generate the image 270. In various examples, the position of the image 270 in the virtual environment 260 of the 3D working product 220 may be aligned with the position of the 3D working product 220 in the physical environment. For example, movement of a head-mounted display may cause relative movement of the virtual environment 260 and the image 270 in the virtual environment 260. In this regard, the 3D printer 210 may be provided with markers that allow the head-mounted display to identify the position of the 3D printer 210 and the 3D working product 220 in the physical environment.

The virtualized environment 260 of the example system 200 further includes a virtualized image 280 of the 3D object 230 being printed by the 3D printer. In this regard, the virtualized image 280 of the 3D object 230 is an image of the completed, substantially completed, or more complete than the printed portion of the 3D object. Thus, as illustrated in the example of FIG. 2, the 3D object 230 is a cup which is partly printed, as illustrated within the working product 220, while the virtualized image 280 illustrates a more complete 3D object. In the virtualized environment 260, the virtualized image 280 of the 3D object is overlapped with the image 270 of the working product or the printed portion of the 3D object. Thus, a user is able to easily monitor the status of printing of the 3D object 230.

In various examples, the virtualized image 280 may be generated by the controller 240 coupled to the display 250. In this regard, the controller 240 may include, or obtain from a data source (e.g., storage medium), data corresponding to the 3D object 230 to allow the controller 240 to generate the virtualized image 280. In some examples, the controller 240 may generate each of the virtual environment 260, the image 270 of the working product and the virtualized image 280 of the 3D object 230. The generated portions are provided by the controller 240 to the display 250 for displaying to the user.

In one example, the virtualized image 280 includes an image of the 3D object 230 in a to-be-printed form. In another example, the virtualized image 280 may include a first portion corresponding to the part of the 3D object 230 that has already been printed and a second portion corresponding to the part of the 3D object 230 that remains to be printed. In this regard, the controller 240 may be coupled to the 3D printer 210 to identify the part of the 3D object 230 that has already been printed. For example, the 3D printer 210 may include or be coupled to a camera that can capture an image of the top layer 226 of the working product 220 and identify a status of the printing based on the visible top layer 232 of the printed portion. The camera may be used to capture image of the top layer 226 as successive layers of build material are deposited. Thus, the camera can capture progress of the printing through images of the successive layers and can update the virtualized image accordingly. For example, images of successive layers may be compared to determine changes in the top layer 232 of the printed portion. In various examples, the controller 230 may generate the first portion of the virtualized image 280 based on information from the 3D printer 210 and the second portion of the virtualized image 280 based on information from a data file corresponding to the 3D object 230.

In one example, the display 250 may display only one portion of the virtualized image 280. For example, the display 250 may present to the user the first portion to indicate how much of the 3D object 230 has been printed. In another example, the display 250 may present to the user the second portion to indicate how much of the 3D object 230 remains to be printed. In some examples, the display 250 may include the entire working product 220. In other examples, the display 250 includes a selected portion of the printed portion of the 3D object 230, such as a portion that is above or below a certain height, for example.

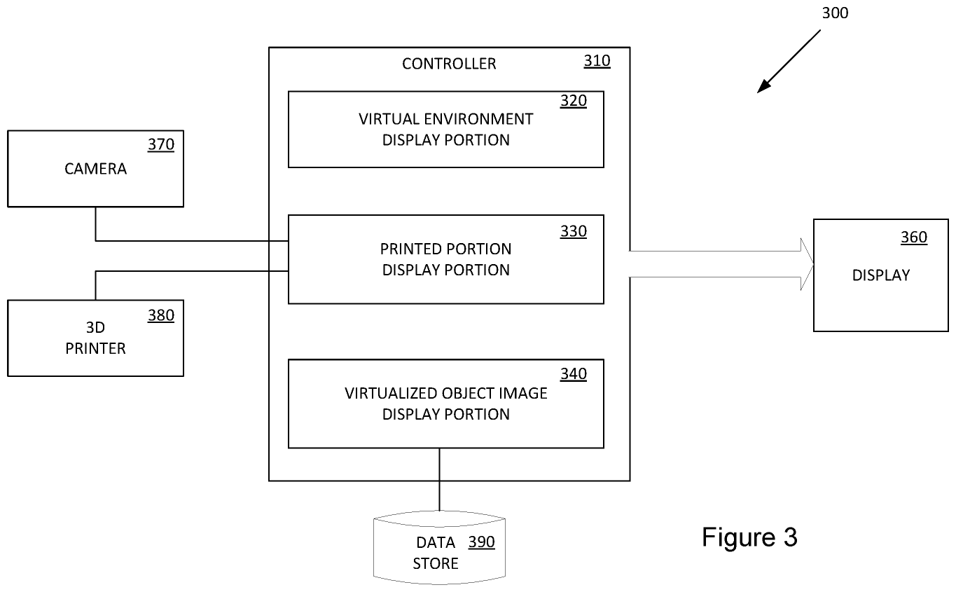

Referring now to FIG. 3, another example virtualization system 300 is illustrated. The example system 300 includes a controller 310 coupled to a display 360. In some examples, the display 360 may include a head-mounted display provided in a headset. In other examples, the display 360 may be any of a variety of monitors. In various examples, a head-mounted display may include a screen or a screen portion for each eye. In one example, the head-mounted display includes a screen that includes a left-eye portion and a right-eye portion corresponding to each eye of the user.

The controller 310 of the example system is provided with a virtual environment display portion 320 to display a virtualized environment, such as the virtualized environment 260 illustrated in FIG. 2, on the display 360. In this regard, the virtual environment display portion 320 may composite various images for display on the display 360. In one example, the display 360 is a head-mounted display, and the virtual environment display portion 320 generates two corresponding images, one for the left-eye portion of the head-mounted display and another for the right-eye portion of the head-mounted display.

The controller 310 further includes a printed portion display portion 330 to display an image of a printed portion of a 3D object or the 3D working product in the virtualized environment. For example, as illustrated in FIG. 2, the image 260 of the working product 220 is displayed in the virtualized environment 260. As described above, the image of a working product containing the printed portion of the 3D object may be displayed on a head-mounted display through a direct view of the physical environment through, for example, a half-silvered mirror. In this regard, since the printed portion may be at least partly embedded within the working product 220, as illustrated in the example of FIG. 2, the image of the printed portion to be displayed may be generated by the controller 310. The image of the printed portion may be generated based on information from the 3D printer 380 or on an image of the working product (e.g., the top layer of the working product) taken by the camera 370. In some examples, the image of the printed portion may be an image of the top layer of the printed portion that is visible, such as the top layer 232 of the 3D object 230 shown in FIG. 2.

In other examples, the printed portion display portion 330 may be coupled to a camera 370 to capture the image of the 3D working product on the 3D printer. In various examples, the camera 370 may be a digital camera to capture a still image or provide a video stream. In some examples, the camera 370 may be provided as part of a headset including a head-mounted display. In other examples, the camera 350 may be provided in another physical position, such as a position that is fixed relative to the 3D printer 380 printing the 3D object.

In other examples, the printed portion display portion 330 is coupled to the 3D printer 380. In this regard, the printed portion display portion 330 may receive information from the 3D printer 380, such as the status of the printing of the 3D object (e.g., percentage complete), an identifier associated with the 3D object, or time remaining for completion of printing of the 3D object. The printed portion display portion 330 may use the information from the 3D printer to generate the image of the printed portion of the 3D object. In some examples, the printed portion display portion 330 may indicate the 3D object, as well as associated 3D-printed accessories, such as support structure for the 3D object.

The controller 310 of the example system 300 of FIG. 3 further includes a virtualized object image display portion 340 to display a virtualized image of the 3D object in the virtualized environment. In one example, as illustrated in FIG. 2, the virtualized object image display portion 340 is coupled to a data store 390 that may store data associated with the 3D object being printed by the 3D printer. In this regard, the data store may include print files with instructions for the 3D printer or may include 3D modeling data corresponding to the 3D object. The virtualized object image display portion 340 may use this information to generate a virtual image of the 3D object for displaying in the virtualized environment presented on the head-mounted display 360.

The controller 310 and the various portions therein (e.g., the virtual environment display portion 320, the printed portion display portion 330, and the virtualized object image display portion 340) may be implemented as hardware, software, firmware or a combination thereof. In one example, the controller 310 is implemented in a processor attached to the display 360. In another example, the controller 310 is external to the display 360, for example, in a processor connected to the display 360 via a cable or wirelessly. In various examples, the controller 310 is implemented as software stored on a non-transitory computer-readable medium and includes instructions that may be executable by a processor.

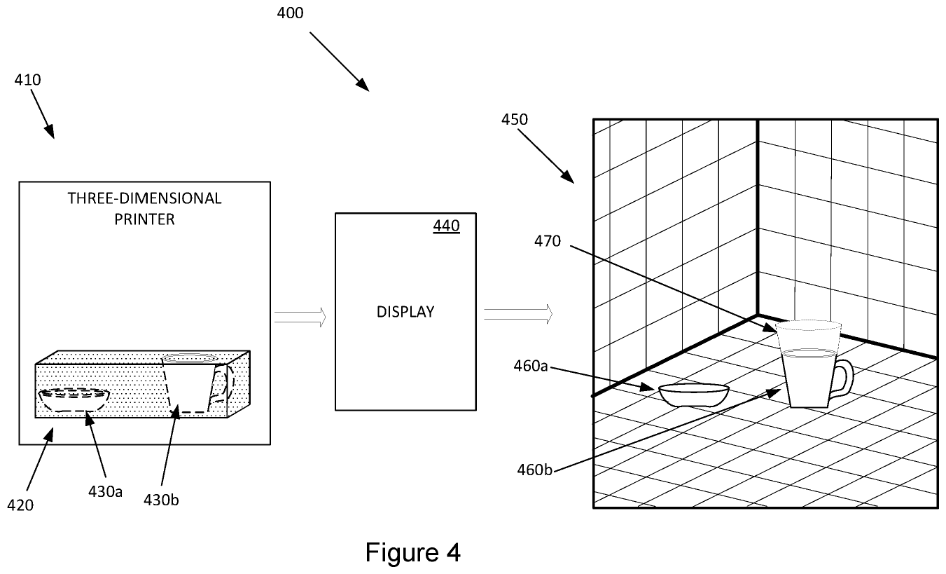

Referring now to FIG. 4, another example virtualization system 400 is illustrated. The example system 400 of FIG. 4 is similar to the example system 200 described above with reference to FIG. 2 and includes a 3D printer 410 and a display 440 for displaying a virtualized environment 450. Of course, as noted above, in various examples, the display 440 may be a head-mounted display or any other type of display, such as a monitor. The example system 400 is illustrated with multiple objects being printed in the 3D printer 410. In the example illustrated in FIG. 3, the 3D printer 410 is printing a first 3D object 430a and a second 3D object 430b. In this regard, the 3D printer 410 is shown producing a working product 420 which may be produced by depositing successive layers of build material, for example. Each 3D object 430a, 430b may be formed by selectively fusing portions of each layer of the build material. The virtualized environment 450 is shown with images 460a, 460b of printed portions of the 3D objects 430a, 430b.

In various examples, as various stages of printing, some of the multiple 3D objects being printed may be complete, while others are only partly printed. In this regard, the example of FIG. 4 illustrates one of the multiple 3D objects being printed, the first object 430a, being completely printed, while another 3D object, the second object 430b, being incomplete. In this regard, a user viewing the virtualized environment 450 can monitor the state of each 3D object. As illustrated in FIG. 4, the virtualized environment 450 includes images 460a, 460b of the printed portions of the 3D objects 430a, 430b and the virtualized image 470 of the second 3D object 430b shown extending beyond the image 460b of the printed portion of the second 3D object. A virtualized image of the first 3D object 430a may also be included in the virtualized environment 450 but is not shown in FIG. 4 for purposes of clarity. In some examples, with printing of one 3D object complete, the user may remove the completed object from the printer for post processing or packaging, for example, while printing of other objects continues.

In some examples, the virtualized environment 450 may be formed based on information from the 3D printer or a controller associated with the 3D printer. In this regard, the virtualized environment may display virtualized images 460a, 460b of printed portions of each 3D object 430a, 430b being printed. In some examples, the virtualized environment 450 may include selected portions of the printed portions of the 3D objects. For example, the virtualized environment 450 may include an image of the printed portion of only the second object 430b without the printed portion of the first object 430a, as may be the case if the first object 430a is an accessory or support structure for the second object 430b. In various examples, the relative locations of the images 460a, 460b of the printed portions may be the same or different compared to the relative locations of the objects 430a, 430b in the physical environment. In various examples, the virtualized images 460a, 460b of the printed portions and the virtualized image 470 of the second 3D object 430b may be generated based on information from a data store, the 3D printer, or a combination thereof.

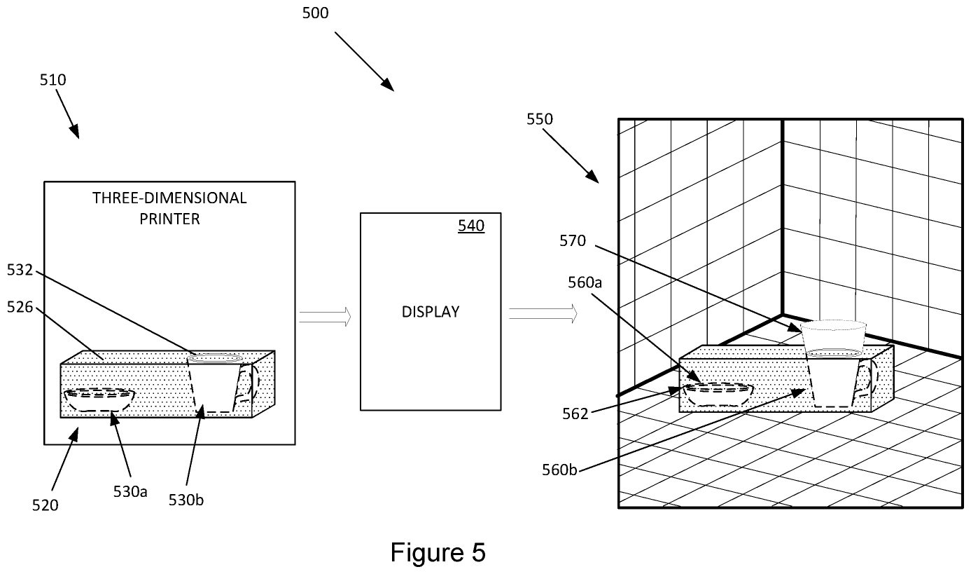

Referring now to FIG. 5, another example virtualization system 500 is illustrated. The example system 500 of FIG. 5 is similar to the example system 400 described above with reference to FIG. 4 and includes a 3D printer 510 and a display 540 for displaying a virtualized environment 550. As with the example system 400 of FIG. 4, the example system 500 of FIG. 5 is illustrated with multiple objects 530a, 530b being printed in the 3D printer 510 as part of a working product 520 which may be produced by depositing successive layers of build material, for example. As described above with reference to FIG. 2, the printed portion of the 3D object 530a, 530b is embedded within the working product 520 and is not visible, and the top layer 526 of the working product 520 is visible, thus exposing the top layer 532 of the printed portion of the second 3D object 530b, as indicated by the solid line in FIG. 5.

In the example of FIG. 5, the virtualized environment 550 of the example system 500 includes an image of the working product 562. In various examples, the image of the working product 562 may or may not include images of printed portions of the 3D objects 560a, 560b. As illustrated in FIG. 5, the top layer of the image of the working product 562 exposes the top layer of the image of the second working product 560b. In the example of FIG. 5, the images of the printed portions 560a, 560b are shown as dotted lines, indicating to the user the location and state of printing of the objects 530a, 530b. As illustrated in FIG. 5, the virtualized environment 550 includes a virtualized image 570 of the second 3D object 530b shown extending beyond the image 562 of the working product. In this regard, a user may be provided with an indication of the portion of the printing still remaining.

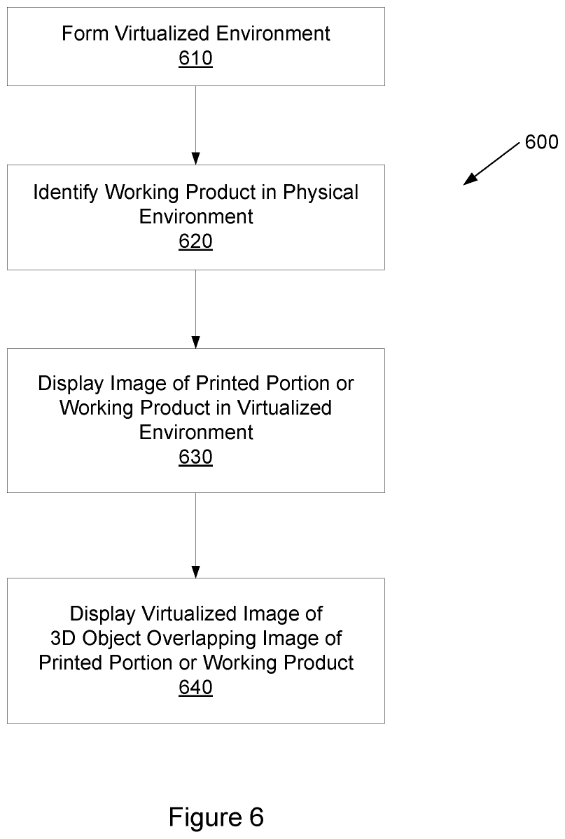

Referring now to FIG. 6, a flow chart illustrating an example method 600 for displaying a virtualized environment for 3D printing is illustrated. The example method 600 may be implemented in, for example, a controller such as the controller 310 of the example system 300 of FIG. 3. The example method 600 includes forming a virtualized environment in a virtual display device (block 610). As described above, the virtual environment may be formed by compositing various images for display on a display, such as a monitor or a head-mounted display.

The example method 600 further includes identifying a working product in a physical environment (block 620). For example, the printing of a 3D object on a 3D printer may be determined or detected by, for example, receiving a signal from the 3D printer or a computing device coupled to the 3D printer. As described above, the working product includes cured material forming a printed portion of the 3D object and uncured material, with the printed portion of the 3D object at least partly embedded in the uncured material. Thus, the status of the printing of the 3D object may not be visible.

The example method 600 further includes displaying an image of at least one of the printed portion of the 3D object or the working product in the virtualized environment (block 630). As described above, displaying of the image of the printed portion of the 3D object (as illustrated in FIG. 4) or the working product (as illustrated in FIG. 5) may include presenting a direct view of the working product on the printer, using an image captured by a camera, or using data received from the 3D printer relating to the progress of the printing.

The example method 600 further includes displaying a virtualized image of the 3D object in the virtualized environment to overlap with the image of the printed portion or the working product (block 640). The virtualized image of the 3D object may be obtained from a data store which includes data (e.g., print data file or 3D model data) corresponding to the 3D object.

In some examples, the virtualized environment may be updated as the printing of the 3D object progresses. For example, the image of the printed portion of the 3D object or the working product may be updated at regular intervals as additional layers of build material are deposited onto the working product. Thus, the user may be presented with an up-to-date status of the printing.

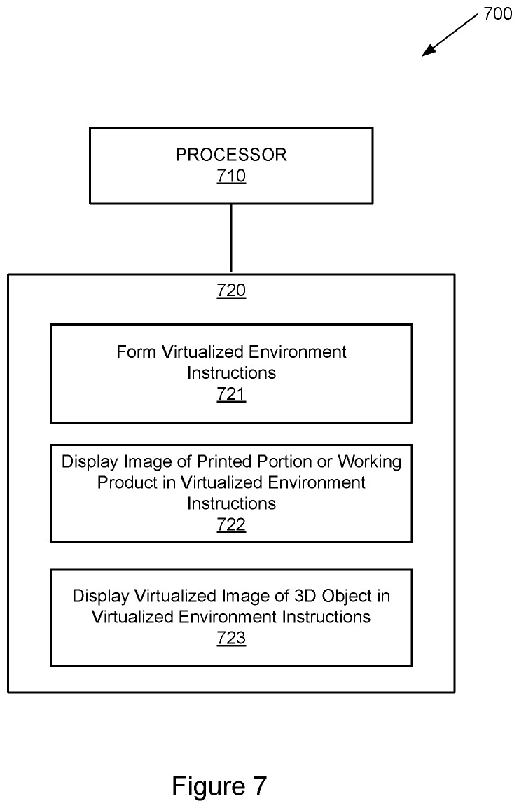

Referring now to FIG. 7, a block diagram of an example system is illustrated with a computer-readable storage medium including instructions executable by a processor for displaying a virtualized environment for 3D printing. The system 700 includes a processor 710 and a non-transitory computer-readable storage medium 720. The computer-readable storage medium 720 includes example instructions 721-723 executable by the processor 710 to perform various functionalities described herein. In various examples, the non-transitory computer-readable storage medium 720 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 710 may be a general purpose processor, special purpose logic, or the like.

The example instructions include form virtualized environment instructions 721. In various examples, a virtualized environment may be formed which includes physical and/or virtual components. The example instructions further include display an image of at least one of a printed portion of a 3D object or a working product in the virtualized environment 722. As described above, the printed portion is part of a working product which includes cured material forming the printed portion of the 3D object and uncured material. The printed portion of the 3D object is at least partly embedded in the uncured material. The example instructions further include display a virtualized image of the 3D object in the virtualized environment instructions 723. In various examples, the virtualized image of the 3D object overlaps with the image of at least one of the printed portion of the 3D object or the working product in the virtualized environment.

Thus, various examples described herein allow a user to monitor the progress of the printing of a 3D object when the printer generates a working product in which the 3D object is embedded within uncured build material. The user can view a virtualized environment in which the working product is overlapped with a virtual image of a more complete 3D object. Thus, the user can view which parts of the 3D object have been printed and which parts still remain to be printed.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
a three-dimensional (3D) printer to produce a 3D working product, the 3D working product including cured material forming a printed portion of a 3D object and uncured material, the printed portion of the 3D object at least partly embedded in the uncured material;
a controller to generate a virtualized image of at least a part of the 3D object;
a display coupled to the controller, the display to display a virtualized environment, the virtualized environment including the virtualized image of the 3D object, the virtualized image of the 3D object corresponding to at least a part of the printed portion of the 3D object.

2. The system of claim 1, wherein the virtualized environment further includes an image of at least a portion of the 3D working product.

3. The system of claim 2, wherein the image of at least a portion of the 3D working product is a top layer of the working product.

4. The system of claim 2, wherein the controller is coupled to a camera, the camera to capture the image of the 3D working product on the 3D printer.

5. The system of claim 1, wherein the virtualized image of the 3D object includes a first portion corresponding the printed portion of the 3D object and a second portion corresponding to a portion of the 3D object to be printed.

6. The system of claim 1, wherein the image of at least a part of the printed portion of the 3D object is a top layer of the printed portion of the 3D object.

7. A method, comprising:
forming a virtualized environment in a virtual display device;
identifying a working product in a physical environment, the working product including cured material forming a printed portion of a 3D object and uncured material, the printed portion of the 3D object at least partly embedded in the uncured material;
displaying an image of at least one of the printed portion or the working product in the virtualized environment; and
displaying a virtualized image of the 3D object in the virtualized environment to overlap with the image of at least one of the printed portion or the working product.

8. The method of claim 7, wherein displaying the image of at least one of the printed portion or the working product includes capturing the image of the 3D working product with a camera.

9. The method of claim 7, wherein displaying the image of at least one of the printed portion or the working product includes generating the image of at least one of the printed portion or the 3D working product based on information from a 3D printer printing the 3D object.

10. The method of claim 7, wherein displaying a virtualized image of the 3D object includes obtaining data associated with the 3D object from a data store.

11. The method of claim 7, further comprising:
updating the image of at least one of the printed portion or the working product in the virtualized environment at a predetermined frequency.

12. A non-transitory computer-readable storage medium encoded with instructions executable by a processor of a computing system, the computer-readable storage medium comprising instructions to:
form a virtualized environment;
display an image of at least one of a printed portion of a 3D object or a working product in the virtualized environment, the working product including cured material forming the printed portion of the 3D object and uncured material, the printed portion of the 3D object at least partly embedded in the uncured material; and
display a virtualized image of the 3D object in the virtualized environment to overlap with the image of at least one of the printed portion or the working product.

13. The non-transitory computer-readable storage medium of claim 12, wherein the instructions to display the image of at least one of the printed portion or the working product includes instructions to capture the image of the 3D working product with a camera.

14. The non-transitory computer-readable storage medium of claim 12, wherein the instructions to display the image of at least one of the printed portion or the working product includes instructions to generate the image of at least one of the printed portion or the 3D working product based on information from a 3D printer printing the 3D object.

15. The non-transitory computer-readable storage medium of claim 12, wherein the instructions to display a virtualized image of the 3D object includes instructions to obtain data associated with the 3D object from a data store.
